(19) United States
(12) Patent Application Publication
(10) Pub. No.: US 2006/0010382 A1
(43) Pub. Date: Jan. 12, 2006

(54) Displaying events by category based on a logarithmic timescale

(76) Inventors: Kohichi Ejiri, Chiba-ken (JP); Toshihiro Kurebayashi, Kanagawa-ken (JP)

Correspondence Address: DICKSTEIN SHAPIRO MORIN & OSHINSKY LLP, 2101 L Street, NW, Washington, DC, 20037, US

(21) Appl. No.: 11/177,368

(22) Filed: Jul. 11, 2005

(30) Foreign Application Priority Data
Jul. 9, 2004 (JP) 2004-203937

(51) Int. Cl. G06F 3/00

(52) U.S. Cl. 715/712; 715/817

(57) ABSTRACT

An apparatus, method, system, computer program and product, each capable of displaying one or more categories, with each category including one or more events; selecting one of the categories; generating a timeline for the selected category based on a logarithmic scale; determining a position of each of the events belonging to the selected category on the timeline; and displaying each of the events at the determined position of the timeline. The categories may be displayed in a three-dimensional form.

This patent application claims priority to Japanese patent application No. 2004-203937 filed on Jul. 9, 2004, in the Japanese Patent Office, the entire contents of which are hereby incorporated by reference.

### FIELD OF THE INVENTION

The following disclosure relates generally to displaying events by category based on a logarithmic timescale.

### DESCRIPTION OF THE RELATED ART

With the increased use of digital storage, there is a need for an effective search tool, which allows a user to easily retrieve a desired data file from a large number of data files stored in digital storage. One search tool uses one or more keywords, which may be included in the contents of the desired data file. However, this keyword search tool may not be effective to retrieve a non-text data file, such as an image or a voice data file, for example. Another search tool uses a date or a time, which may be related to time information, such as the creation date, of the desired data file. However, this calendar search tool may not be effective when the user wants to retrieve a data file created a long time ago, as the user may not remember when the data file was created.

To make the calendar search tool more effective, human time perception may need to be considered. According to Weber Fechner's Law, a perceived signal I increases proportionally to the logarithm of an outside stimulant S, as described in the equation: k*log S=I, with k being a constant. If this law is valid for human time perception, it can be assumed that human time perception is based on a logarithmic timescale. This explains why a human tends to recall a current event with a shorter time interval, while not tending to recall a past event with a longer time interval with specificity.

For example, when recalling a particular event that happened on Jun. 1, 2005, which is ten days from the current date of Jun. 11, 2005, a human may recall all events that happened between May 31, 2005 and Jun. 2, 2005. On the other hand, when recalling a particular event that happened on Jun. 1, 1995, which is ten years from the current date of Jun. 11, 2005, a human may recall all events that happened in the year 1995.

However, a human may recall an event that happened 10 years ago with a shorter time interval, if such an event has a special meaning. On the other hand, a human may recall an event that happened 10 days ago with a longer time interval, if such an event indicates a daily routine. It can be thus assumed that human time perception differs depending on the type of the particular event.

### BRIEF SUMMARY OF THE INVENTION

An exemplary embodiment of the present invention includes an apparatus, method, system, computer program and product, each capable of displaying events by category based on a logarithmic timescale.

Another exemplary embodiment of the present invention includes an apparatus, method, system, computer program and product, each capable of displaying categories based on a logarithmic timescale in a three-dimensional form.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a structure of an event display apparatus according to an exemplary embodiment of the present invention;

FIG. 2 is an event management table according to an exemplary embodiment of the present invention;

FIG. 3 is a category management table according to an exemplary embodiment of the present invention;

FIG. 4 is an illustration of exemplary categories displayed by the event display apparatus of FIG. 1 according to an exemplary embodiment of the present invention;

FIG. 5 is an illustration of an exemplary frame formed by the event display apparatus of FIG. 1 according to an exemplary embodiment of the present invention;

FIG. 6 is an illustration of exemplary events by category, displayed by the event display apparatus of FIG. 1 according to an exemplary embodiment of the present invention;

FIG. 7 is an illustration of exemplary events by category, displayed by the event display apparatus of FIG. 1 according to an exemplary embodiment of the present invention;

FIG. 8 is an illustration of exemplary events by category, displayed by the event display apparatus of FIG. 1 according to an exemplary embodiment of the present invention;

FIG. 9 is an illustration of an operation for providing an event data file performed by the event display apparatus of FIG. 1 according to an exemplary embodiment of the present invention;

FIG. 10 is a block diagram illustrating a structure of an event display system according to an exemplary embodiment of the present invention;

FIG. 11 is a block diagram illustrating a structure of an event display apparatus according to an exemplary embodiment of the present invention;

FIG. 12 is an illustration of an operation for providing an event data file performed by the event display apparatus of FIG. 11 according to an exemplary embodiment of the present invention;

FIG. 13 a block diagram illustrating a structure of an event display system according to an exemplary embodiment of the present invention;

FIG. 14 is a block diagram illustrating a structure of an event display apparatus according to an exemplary embodiment of the present invention;

FIG. 15 is an illustration of an exemplary clustering operation, performed by the event display apparatus of FIG. 14 according to an exemplary embodiment of the present invention;

FIG. 16 is an illustration of exemplary events by category, displayed by the event display apparatus of FIG. 14 according to an exemplary embodiment of the present invention;

FIG. 17 is an illustration of exemplary events by category, displayed by the event display apparatus of FIG. 14 according to an exemplary embodiment of the present invention;

FIG. 18 is a block diagram illustrating a structure of an event display apparatus according to an exemplary embodiment of the present invention;

FIG. 19 is an illustration of exemplary categories, displayed by the event display apparatus of FIG. 18 according to an exemplary embodiment of the present invention; and

FIG. 20 is an illustration of exemplary categories, displayed by the event display apparatus of FIG. 18 according to an exemplary embodiment of the present invention.

### DETAILED DESCRIPTION OF THE INVENTION

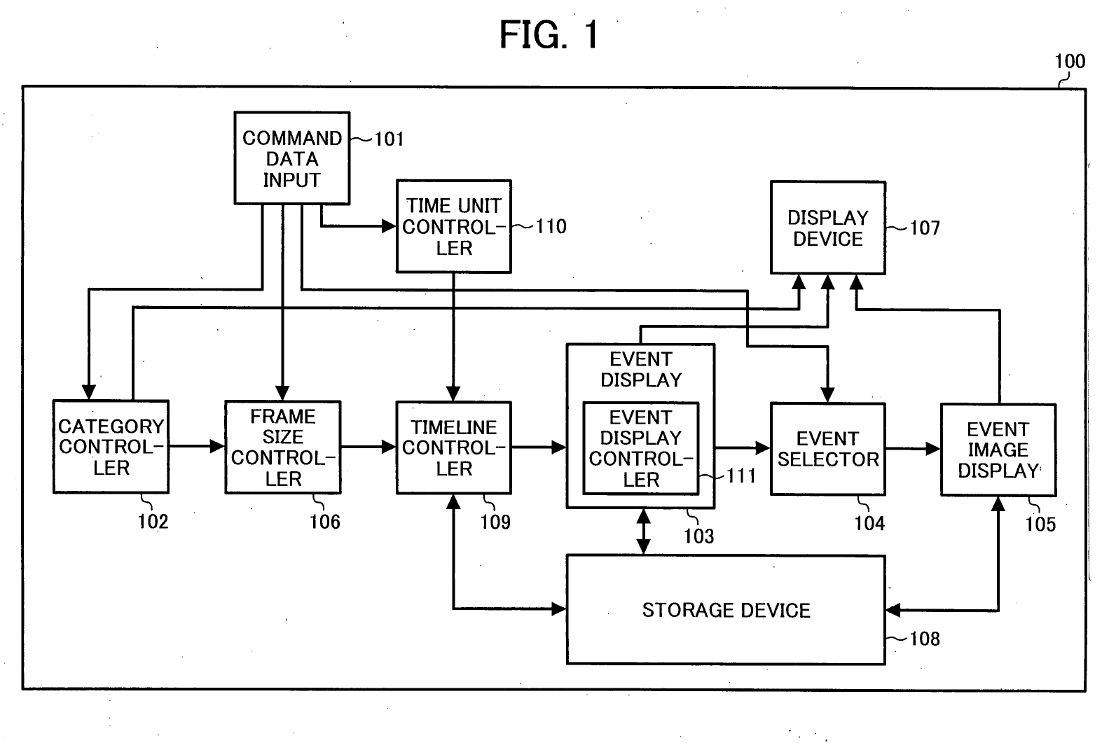

In describing the preferred embodiments illustrated in the drawings, specific terminology is employed for clarity. However, the disclosure of this patent specification is not intended to be limited to the specific terminology selected and it is to be understood that each specific element includes all technical equivalents that operate in a similar manner. Referring now to the drawings, wherein like reference numerals designate identical or corresponding parts throughout the several views. FIG. 1 illustrates an event display apparatus 100 according to an exemplary embodiment of the present invention.

The event display apparatus 100 is capable of displaying events by category based on a logarithmic timescale. In the following disclosure, the event includes any kind of event perceivable to a user. As described below, the event may include a current or future event in addition to a past event experienced by the user, as long as the current or future event can be perceivable to the user. In this exemplary embodiment, the event corresponds to at least one of event data files stored in the storage device 108. Examples of the event data file include a document data file, an image data file, or a voice data file.

Further, the events can be classified into one or more categories, depending on the type of the events. In this exemplary embodiment, the event display apparatus 100 determines the category of an event using properties information contained in the corresponding event data file. Alternatively, the event display apparatus 100 may determine the category of the event using the name of a directory or folder in a file system. Specifically, in this exemplary embodiment, the events stored in the storage device 108 are classified into a plurality of categories including the “Work Document” category, the “Work Picture” category, the “Personal Picture” category, the “Travel Picture” category, and the “Map” category.

The event display apparatus 100 includes command data input 101, category controller 102, event display 103 including event display controller 111, event selector 104, event image display 105, frame size controller 106, display device 107, storage device 108, timeline controller 109, and time unit controller 110.

The storage device 108 may be implemented by any kind of memory such as ROM (read only memory) or RAM (random access memory), or any kind of HDD (hard disk drive), for example. In addition to the event data files, the storage device 108 stores event time information and event properties information, in a corresponding manner, for each of the event data files on the category basis. For example, an event management table may be created for each of the categories, which stores event time information and event properties information of the event data files belonging to the same category.

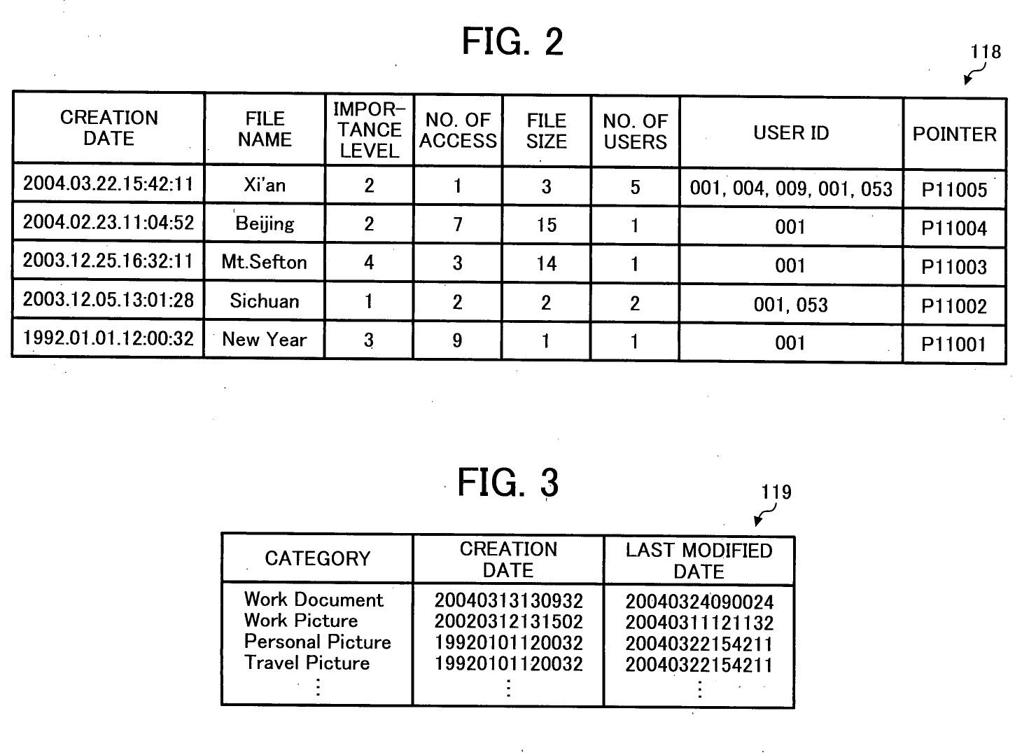

FIG. 2 illustrates an event management table 118 created for the “Travel Picture” category, according to an exemplary embodiment of the present invention. The event management table 118 stores event time information and event properties information for each of the event data files belonging to the “Travel Picture” category.

In this exemplary embodiment, the event time information indicates a specific date (“event date”) representing the event. As shown in FIG. 2, the event time information indicates, for example, the creation date indicating the date and/or time of which the event data file is first created. Alternatively, the event time information may indicate the last access date indicating the date and/or time of which the event data file is last accessed. Alternatively, the event time information may indicate the last modified date indicating the date and/or time of which the event data file has been last modified.

In this exemplary embodiment, the event properties information includes any kind of information, other than the event time information, representing the event. As shown in FIG. 2, the event properties information indicates, for example, the file name, importance level, number of access, file size, number of users, user ID, and reference pointer of the event data file. The file name corresponds to the name or tide assigned to the event data file. The importance level corresponds to a degree of importance, which may be assigned to the event data file. The number of access corresponds to the number of which the event data file is accessed by a user. The file size corresponds to the size of the event data file. The number of users corresponds to the number of authorized users, who has access to the event data file. The user ID corresponds to a flag used to identify a user accessing the event data file. The reference pointer indicates the location where the event data file is stored.

In addition to the event data files, the event time information, and the event properties information, the storage device 108 may store category time information of each of the categories. In this exemplary embodiment, the category time information may be preferably used for determining a starting date and an ending date of a timeline to be generated for each of the categories. The category time information of the category may be derived from the event time information of the events belonging to the category. In this exemplary embodiment, the event display apparatus 100 creates a category management table storing category time information of each of the categories using the event management tables.

FIG. 3 illustrates a category management table 119 stored in the storage device 108, according to an exemplary embodiment of the present invention. As shown in FIG. 3, the category management table 119 stores the creation date for each of the categories as the ending date of the timeline for each of the categories. Further, the category management table 119 stores the last modified date for each of the categories as the starting date of the timeline for each of the categories. Alternatively, the category management table 119 may store any other kind of a combination of starting date and ending date. For example, the last accessed date may be stored as the starting date of the timeline for each of the categories.

The category time information of the category, such as the creation date or the last modified date shown in FIG. 3, is determined based on the event time information of the event data files belonging to that category.

In the exemplary case of the “Travel Picture” category, the creation dates of the event data files in the “Travel Picture” category are compared with one another, and the earliest creation date “19920101120032” is obtained as the creation date for the “Travel Picture” category. Similarly, the last modified dates of the event data files in the “Travel Picture” category are compared with one another, and the latest last modified date “20040322154211” is obtained as the last modified date for the “Travel Picture” category.

Referring back to FIG. 1, the command data input 101 receives command data from a user and provides it to the category controller 102, the frame size controller 106, the event selector 104, or the time unit controller 110. For example, the command data may be a signal input by the user. The user may input the signal through an input device such as a keyboard or a mouse, for example.

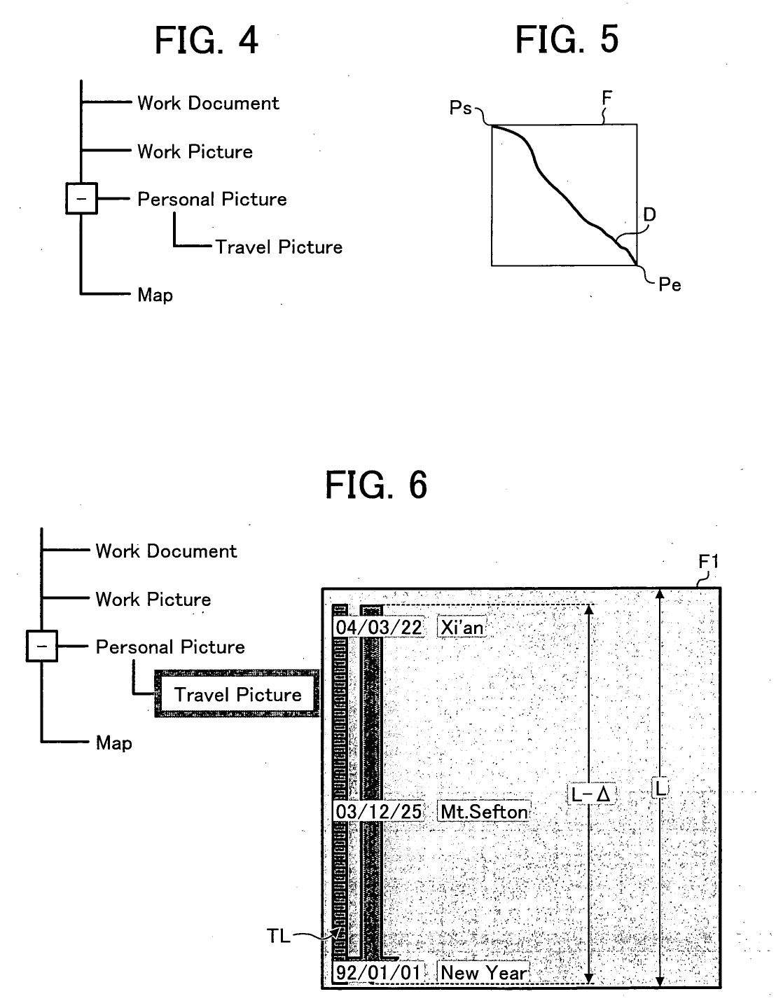

The category controller 102 displays the categories of the events on the display device 107. In this exemplary embodiment, the categories are displayed in a tree structure, as illustrated in FIG. 4. In addition, the category controller 102 may select one of the categories according to the command data received from the user via the command data input 101.

The frame size controller 106 determines a size of a frame to be displayed on the display device 107. For example, as illustrated in FIG. 5, the frame F may have a rectangular shape having a start point Ps. When the user draws a line D from the point Ps with the input device, an end point Pe is input as command data to the command data input 101. According to this command data, the frame size controller 106 determines a size of the frame F. Alternatively, the size of the frame F may be previously determined. Further, the size of the frame F may be changed any time according to command data input by the user.

Referring back to FIG. 1, the timeline controller 109 generates a timeline for the category selected by the category controller 102, using the category time information. Further, the timeline controller 109 determines the position of each of the events to be displayed on the timeline using the event time information. Once the position is determined, the event display 103 displays the timeline and the event at the determined position along the timeline on the display device 107.

Referring to FIG. 6, an exemplary operation of generating a timeline TL for the “Travel Picture” category, and determining the position of the event belonging to the “Travel Picture” category is explained according to an exemplary embodiment of the present invention.

First, the timeline controller 109 determines a starting date and an ending date of the timeline, using the category time information stored in the storage device 108. In this exemplary embodiment, the starting date of the timeline corresponds to the last modified date of the category, while the ending date of the timeline corresponds to the creation date of the category.

In the exemplary case of the “Travel Picture” category, the timeline controller 109 obtains the creation date “19920101120032” (92/01/01) and the last modified date “20040322154211” (04/03/22) from the category management table 119. The timeline controller 109 calculates a time period between the creation date (92/01/01) and the last modified date (04/03/22), and obtains the time period 4472 days. The timeline controller 109 further calculates the logarithm of 4472 in base 10: log4472=3.65. In this exemplary embodiment, the base of 10 is used to calculate the logarithm, however, a base of any number may be used. For example, the user may select the desired base by inputting the corresponding command data via the command data input 101.

Next, the timeline controller 109 refers to the size of the frame F1 determined by the frame size controller 106, and obtains the length L of the frame F1. In this exemplary embodiment, the length of the timeline TL is made substantially equal to the length (L−Δ), with the value Δ indicating the length of margins provided at both upper and lower edges of the frame F1. Further, the length of the timeline TL, i.e., the length (L−Δ), corresponds to the time period between the creation date (92/01/01) and the last modified date (04/03/22). Accordingly, the unit length l of the timeline TL corresponding to the logarithmic value 1 can be calculated using the following equation: l=(L−Δ)/3.65=300. In this exemplary embodiment, the length L, Δ, or l is expressed in number of pixels displayed on the display device 107. This unit length l is used as a conversion factor for converting the time information expressed in logarithmic value to positional information expressed in the number of pixels.

To determine the position of a specific event on the timeline TL, the timeline controller 109 calculates a time period between the starting date of the timeline and the event date of the event. In this exemplary embodiment, the timeline controller 109 calculates a time period between the last modified date (04/03/22) of the “Travel Picture” category and the creation date of the event data file representing the specific event. The obtained time period is further converted to the logarithmic value. The logarithmic value is then multiplied by the conversion factor of 300 to obtain positional information of the specific event, which indicates a distance from the starting date, i.e., the last modified date (04/03/22), of the timeline TL. Based on the positional information, the position of the specific event on the timeline TL is determined.

For example, to determine the position of the event “Mt. Sefton,” the timeline controller 109 calculates a time period between the last modified date (04/03/22) and the creation date (03/12/25) of the event data file having the file name “Mt. Sefton.” The resultant time period 94 days is further converted to the logarithmic value: log94=1.97. The obtained logarithmic value 1.97 is further multiplied by the conversion factor of 300:1.97*300=591. Thus, the position of the event “Mt. Sefton” is determined to be 592 pixels away from the starting date (04/03/22) of the timeline TL.

Once the position for the event “Mt. Sefton” is determined, the event display 103 displays the frame F1, and further displays, within the frame F1, the event “Mt. Sefton” at the determined position on the timeline TL, as illustrated in FIG. 6.

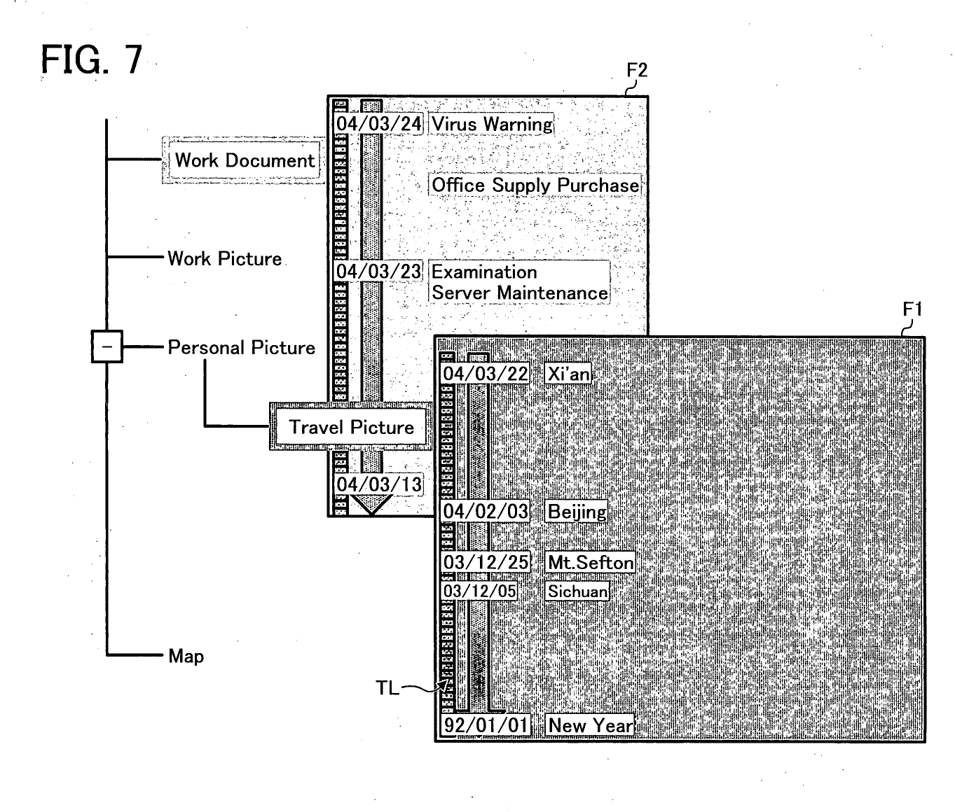

When displaying the frame on the display device 107, the event display 103 may select a specific color or intensity level of the frame according to the selected category. For example, as illustrated in FIG. 7, if a frame F2 for the “Work Document” category is previously displayed on the display device 107, the frame F1 for the “Travel Picture” category may be displayed with a color darker than the color of the frame F2. In this way, frames belonging to different categories can be easily distinguished from one another.

Further, the event display 103 may display the event in various ways.

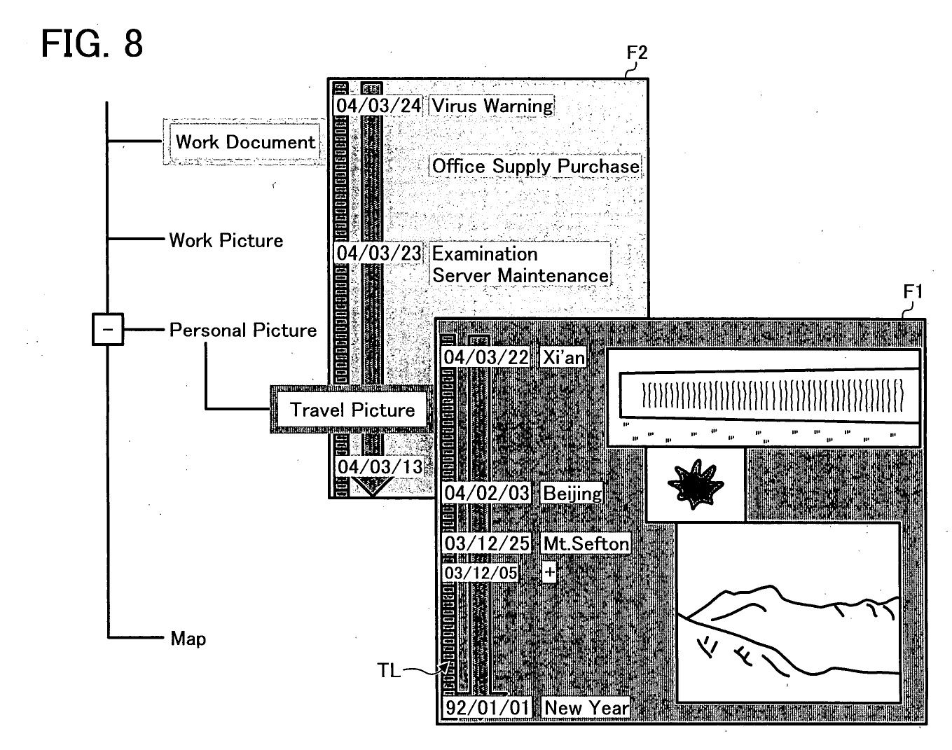

In one example, the event display 103 may display the event using any kind of information relating to the corresponding event data file. As shown in FIG. 6, the event display 103 may display the event, using the file name of the corresponding event data file and the corresponding event date. As shown in FIG. 8, the event display 103 may display a thumbnail image of the event data file along with the file name. Alternatively, the event display 103 may display the event, using a part of the file name of the event data file.

In another example, the event display 103 may change a font size or an indent space of the event according to the importance level of the corresponding event data file. For example, as shown in FIG. 2, the event data file having the file name “Sichuan” has the importance level of 1, which is relatively low compared to the importance levels of the other event data files in the “Travel Picture” category. Thus, the event “Sichuan” may be displayed with a smaller font, as illustrated in FIG. 7. Alternatively, the event display 103 may change a size of the thumbnail image according to the importance level of the corresponding event data file.

In another example, the event display 103 may display the event with a mark according to the importance level of the corresponding event data file, as illustrated in FIG. 8. In this exemplary embodiment, an event display controller 111 is provided in the event display 103 of FIG. 1. The event display controller 111 may determine to display one or more of the events with the marks “+” when the events on the timeline are located too closely from one another. Preferably, the event displayed with the mark “+” corresponds to an event data file having a lower importance level. If the user selects the mark “+” with the input device, the event display 103 may display, for example, the file name of the event data file on the timeline TL.

Furthermore, the event display 103 may display the event, only when the corresponding event data file has the user ID that matches with a user ID of the current user. For example, referring back to FIG. 2, if the user having the user ID 053 is logged onto the event display apparatus 100, only the event “Xi′an” corresponding to the event data file “Xi′an” and the event “Sichuan” corresponding to the event data file “Sichuan” may be displayed on the display device 107.

In this exemplary embodiment, the importance level of each data file may be previously determined by a user. Alternatively, the importance level may be determined based on any event time information or event properties information stored in the storage device 108, for example.

In one example, the number of access or the last access date may be used to determine the importance level of each event data file. For example, the event data file having a number of accesses that is relatively high may be assigned a lower importance level.

In another example, the creation date may be used to determine the importance level of each event data file. For example, the creation dates of event data files belonging to the same category may be compared with one another to specify a blank time period having no or a relatively small number of event data files. The event data file having the creation date following the specified blank time period may be assigned with a higher importance level.

In another example, the file name and the creation date may be used to determine the importance level of each event data file. For example, the file names of event data files belonging to the same category may be compared with one another to classify the event data files into a plurality of groups based on similarities of the file names. Further, the creation dates of the event data files belonging to the same group are compared with one another to specify the event data file having the earliest creation date, for example. The event data file having the earliest creation date may be assigned with an importance level higher than the importance level assigned to any other event data file belonging to the same group.

Referring back to FIG. 1, the time unit controller 110 determines a time unit of the timeline displayed on the display device 107. In this exemplary embodiment, the timeline TL is displayed in the time unit expressed in “Year/Month/Date” by default. However, the user may change this default time unit to any kind of time unit, such as “hour/minute/second” or “month,” for example, by sending command data via the input device.

In one example, a plurality of keys or buttons may be displayed on the display device 107, with each indicating time, day, week, and month, respectively. If the user selects one of the keys or buttons using the input device, the command data indicating the selection is input to the time unit controller 110 via the command data input 101. According to this command data, the time unit controller 110 changes a time unit, and instructs the timeline controller 109 to convert time information, including the event date, starting date, or ending date, for example, from the default time unit to the selected time unit. Based on the time information expressed in the selected time unit, the timeline controller 109 obtains the positional information expressed in the number of pixels. Using the positional information, the event display 103 displays the event on the timeline in the selected time unit.

However, if the month is used by default, the time period between the starting date of the timeline and the event date of a specific event may become negative. In such a case, the timeline controller 109 may not be able to determine the position of the event in a suitable manner.

Still referring to FIG. 1, the event selector 104 selects one of the events displayed on the display device 107 according to command data received from the user via the command data input 101.

The event image display 105 acquires an event data file corresponding to the selected event by referring to the reference pointer stored in the event management table. The acquired event data file is displayed on the display device 107.

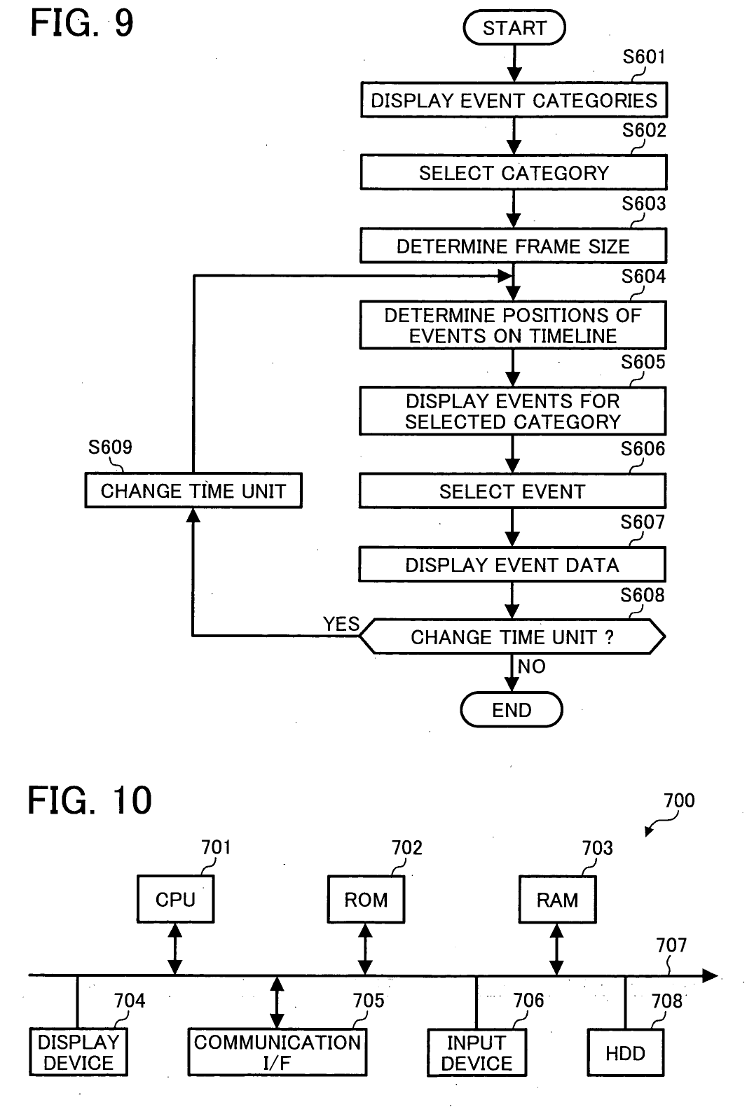

Referring to FIG. 9, an operation of providing an event data file, performed by the event display apparatus 100, is now explained according to an exemplary embodiment of the present invention.

In Step S601, the category controller 102 displays the categories of the events on the display device 107.

In Step S602, upon receiving command data for category selection from the user via the command data input 101, the category controller 102 selects one of the categories selected by the user.

In Step S603, the frame size controller 106 determines a size of a frame for the selected category. In one example, the frame size may be determined based on command data received from the user via the command data input 101.

In Step S604, the timeline controller 109 generates a timeline for the selected category, and determines the position of each of the events to be displayed on the timeline.

In Step S605, the event display 103 displays the frame for the selected category. Within the frame, the event display 103 further displays the events at the respective determined positions on the timeline. At this time, the event display 103 may change view of the events based on the event time information or the event properties information.

In Step S606, upon receiving command data for event selection from the user via the command data input 101, the event selector 104 selects one of the events selected by the user.

In Step S607, the event image display 105 displays an event data file corresponding to the selected event on the display device 107.

In Step S608, the command data input 101 determines whether command data for time unit change has been input by the user. If it is determined that the command data has been input (“YES” in Step S608), the operation proceeds to Step S609. Otherwise (“NO” in Step S608), the operation ends.

In Step S609, the time unit controller 110 changes a default or previously set time unit to a time unit specified by the user, and the operation repeats steps S604 to S608.

The steps illustrated in the flowchart of FIG. 9 may be performed in different orders, as it is apparent to those skilled in the art. Further, the operation performed by the event display apparatus 100 is not limited to this exemplary operation shown in FIG. 9.

For example, any kind of category time information may be used to determine the starting date or the ending date of the timeline. Further, current time information indicating the current time may be used as the starting date of the timeline.

In another example, the timeline may be displayed on a linear scale. For example, one or more keys or button may be displayed on the display device 107, which allow a user to switch between the linear timescale and logarithmic timescale.

Furthermore, any one of the operations performed by the event display apparatus 100 may be performed by any kind of processor capable of operating according to an event display program of the present invention.

FIG. 10 illustrates an event display system 700 according to an exemplary embodiment of the present invention. The event display system 700 includes CPU (central processing unit) 701, ROM 702, RAM 703, display device 704, communication I/F (interface) 705, input device 706, and HDD 708, which are connected to one another via bus 707.

The CPU 701 includes any kind of processor capable of controlling the operation of the system 700 according to the event display program. The ROM 702 includes any kind of involatile memory. The RAM 703 includes any kind of volatile memory. The HDD 708 includes any kind of storage device capable of storing various kinds of data. The communication I/F 705 allows the system 700 to communicate with other devices or apparatuses via a communication line or a network. The display device 704 includes any kind of display, such as a liquid crystal display, for example. The input device 706 includes any kind of device allowing a user to input an instruction, such as a keyboard or a mouse, for example.

In one example, the event display program may be installed onto the HDD 708 from a recording medium storing the event display program. Examples of the recording medium include, but not limited to, optical discs such as CD-ROM, CD-R, CD-RW, DVD-ROM, DVD-RAM, DVD-R, DVD+R, DVD-RW, DVD+RW, magneto optical discs, memory cards, and flexible disks. The event display program may be further loaded onto the ROM 702 upon activation of the CPU 701.

In another example, the event display program may be downloaded from any device or apparatus via the network, such as the Internet, through the communication I/F 705. The event display program may be further loaded onto the ROM 702 upon activation of the CPU 702.

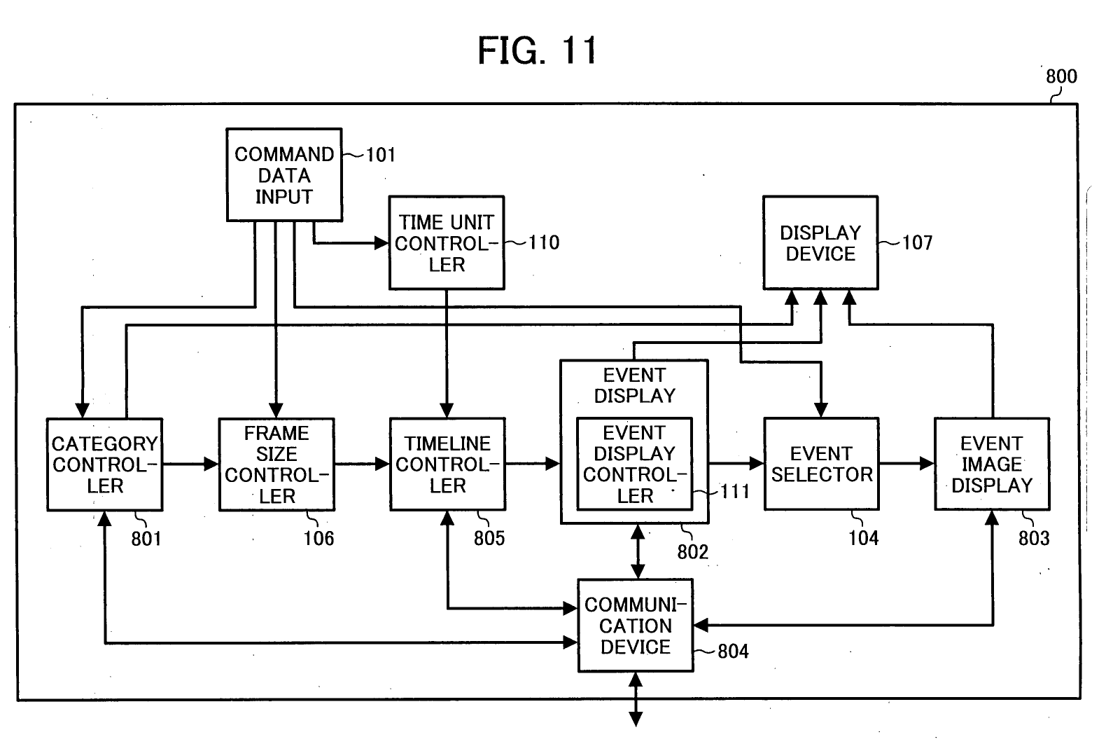

Referring now to FIG. 11, an event display apparatus 800 is explained according to an exemplary embodiment of the present invention. The event display apparatus 800 is substantially similar in structure to the event display apparatus 100 of FIG. 1. The differences include category controller 801, event display 802 including the event display controller 111, event image display 803, communication device 804, and timeline controller 805.

The event display apparatus 800 is capable of displaying events by category based on a logarithmic timescale. However, in this exemplary embodiment, an event corresponds to at least one of event data files is obtainable from a network via the communication device 804.

The category controller 801 obtains category data, which indicates categories of the events, from the network via the communication device 804. Based on the category data, the category controller 801 displays the categories of the events on the display device 107, preferably, in a tree structure, as illustrated in FIG. 4, for example. In addition, the category controller 801 may select one of the categories according to the command data received from the user via the command data input 101.

The timeline controller 805 acquires event time information of the event data files belonging to the selected category from the network. At this time, the timeline controller 805 may obtain a portion of or the entire properties information for the event data files of the selected category. Using the obtained event time information, the timeline controller 805 generates a timeline for the selected category, and determines the respective positions of the events on the timeline, in a substantially similar manner performed by the timeline controller 109.

The event display 802 displays the events at the determined positions on the timeline, in a substantially similar manner performed by the event display 103. At this time, the event display 802 may acquire, from the network, a portion of or the entire event properties information for the event data files of the selected category. Alternatively, or in addition, the event display 802 may acquire, from the network, information necessary for displaying a thumbnail image of the event belonging to the selected category.

The event image display 803 acquires an event data file corresponding to one of the events, which has been selected by the user, from the network via the communication device 804.

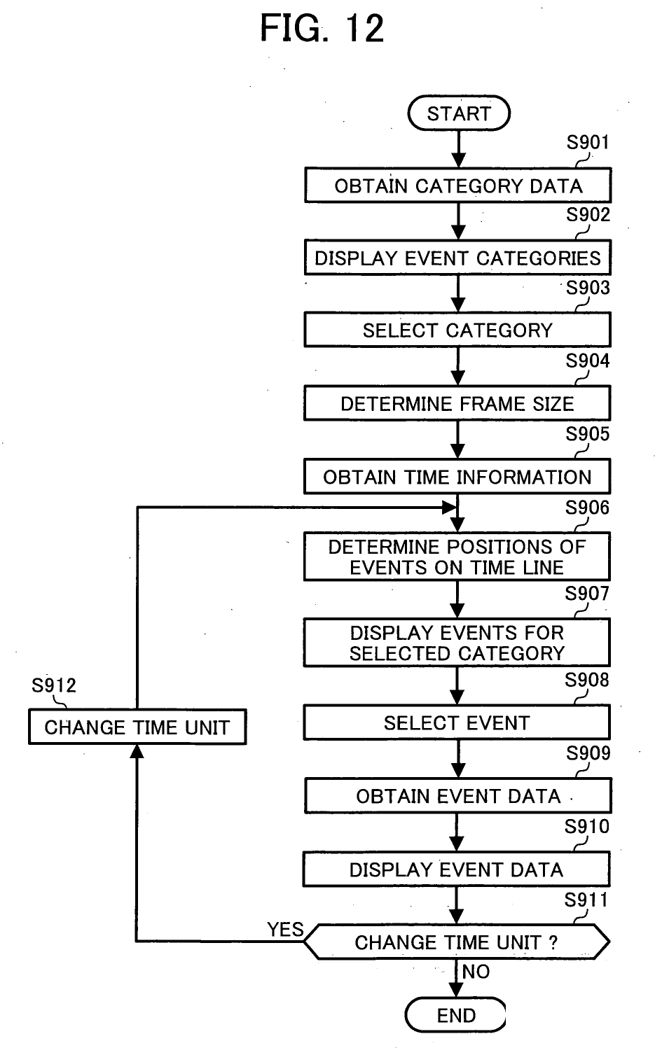

Referring to FIG. 12, an operation of providing an event data file, performed by the event display apparatus 800, is now explained according to an exemplary embodiment of the present invention.

In Step S901, the category controller 801 obtains category data from the network via the communication device 804.

In Step S902, the category controller 801 displays the categories of the events on the display device 107.

In Step S903, upon receiving command data for category selection from the user via the command data input 101, the category controller 801 selects one of the categories selected by the user.

In Step S904, the frame size controller 106 determines a size of a frame for the selected category.

In Step S905, the timeline controller 802 obtains event time information of the event data files belonging to the selected category from the network via the communication device 804.

In Step S906, the timeline controller 802 generates a timeline for the selected category, and determines the position of each of the events to be displayed on the timeline.

In Step S907, the event display 802 displays the frame for the selected category. Within the frame, the event display 802 further displays the events at the respective determined positions on the timeline. At this time, the event display 103 may change view of the events, according to event time information or event properties information.

In Step S908, upon receiving command data for event selection from the user via the command data input 101, the event selector 104 selects one of the events selected by the user.

In Step S909, the event image display 803 obtains an event data file corresponding to the selected event from the network via the communication device 804.

In Step S910, the event image display 803 displays the event data file on the display device 107.

In Step S911, the command data input 101 determines whether command data for time unit change has been input by the user. If it is determined that the command data has been input (“YES” in Step S911), the operation proceeds to Step S912. Otherwise (“NO” in Step S911), the operation ends.

In Step S912, the time unit controller 110 changes a default or previously set time unit to a time unit specified by the user, and the operation repeats steps S906 to S911.

The steps illustrated in the flowchart of FIG. 12 may be performed in different orders, as it is apparent to those skilled in the art. Further, the operation performed by the event display apparatus 800 is not limited to this exemplary operation shown in FIG. 12.

For example, any kind of category time information or current time information may be used to define a time period corresponding to the length of the timeline. In another example, the timeline may be displayed based on a linear scale.

Furthermore, any one of the operations performed by the event display apparatus 800 may be performed by any kind of processor capable of operating according to an event display program of the present invention.

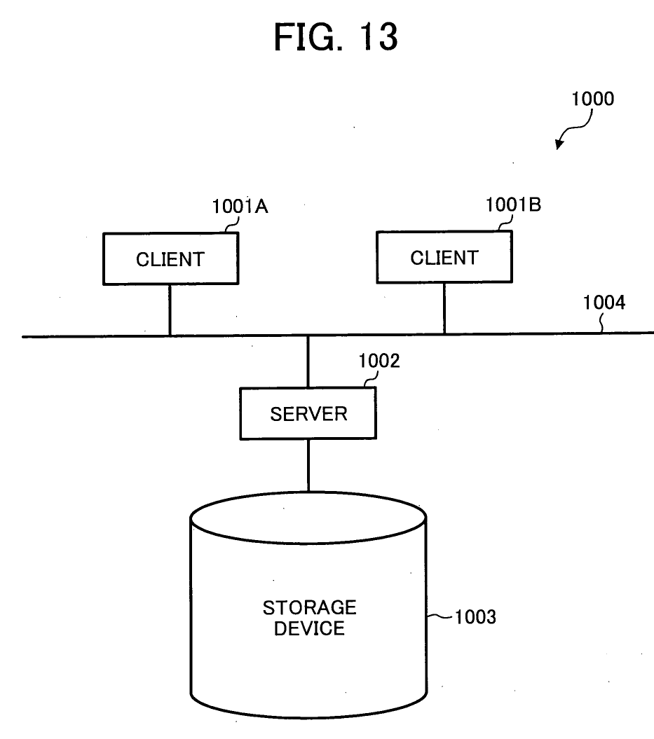

FIG. 13 illustrates an event display system 1000 according to an exemplary embodiment of the present invention. The event display system 1000 includes two clients 1001A and 1001B, a server 1002, and a storage device 1003, which are connected to one another via a network 1004.

Any one of the clients 1001A and 1001B may be implemented by a processor capable of controlling the system 1000 according to the event display program, such as a personal computer, for example. The server 1002 includes any kind of processor capable of communicating with any one of the clients 1001A and 1001B, such as a personal computer, for example. The storage device 1003 includes any kind of memory or storage device, such as a HDD. In this exemplary embodiment, the storage device 1003 stores a plurality of event management tables, a category management table, and a plurality of event data files. The network 1004 includes any kind of wired or nonwired network, including PSTN (Public Switched Telephone Network), LAN, and the Internet, for example.

Alternatively, the server 1002 and the storage device 1003 may be incorporated into one apparatus. For example, the server 1002 and the storage device 1003 may be implemented by a personal computer having a memory. In another example, the server 1002 and the storage device 1003 may be implemented by a multifunctional peripheral device (MFP).

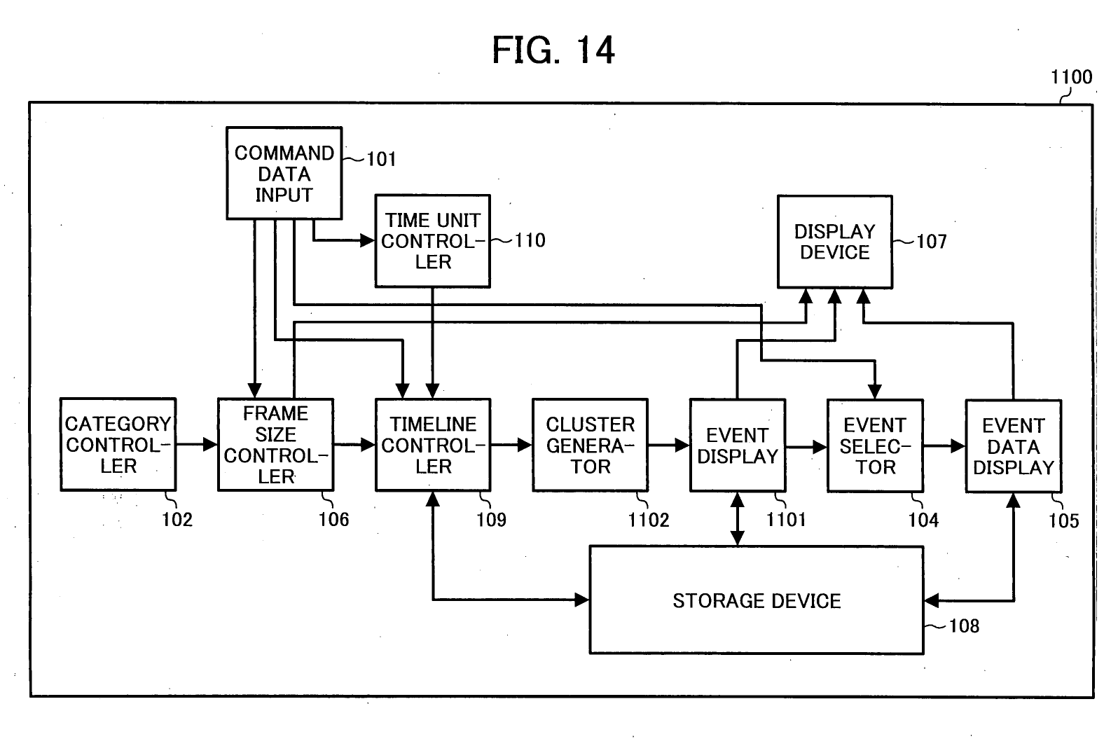

Referring to FIG. 14, an event display apparatus 1100 is now explained according to an exemplary embodiment of the present invention. The event display apparatus 1100 is substantially similar in structure to the event display apparatus 100 of FIG. 1. The differences include cluster generator 1102, and event display 1101.

The cluster generator 1102 determines whether to group a plurality of events into one cluster, when the events on the timeline are located too closely to one another, for example.

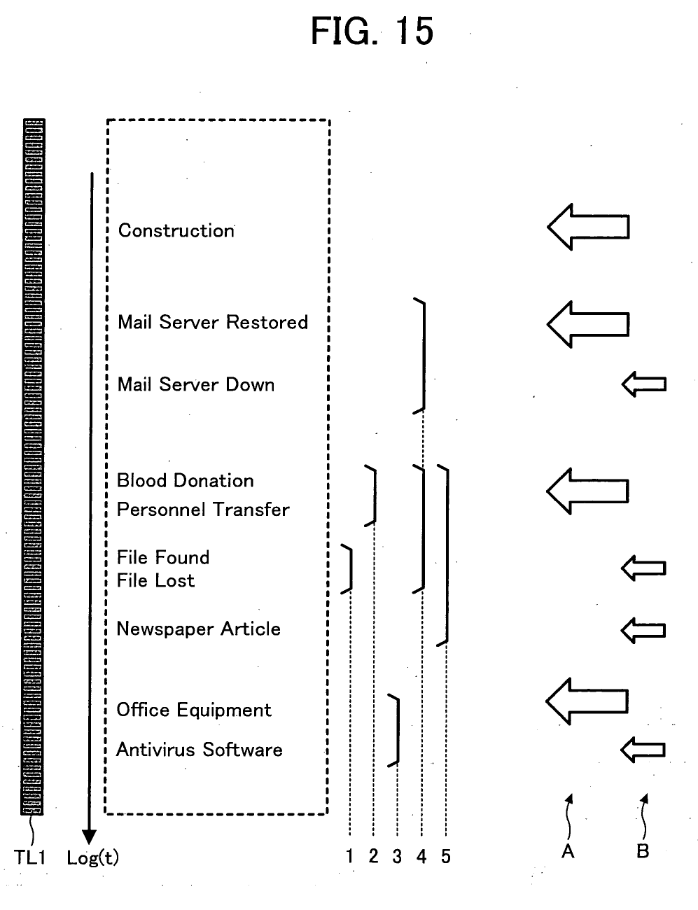

Referring now to FIGS. 15 to 17, an operation of clustering, performed by the cluster generator 1102, is explained according to an exemplary embodiment of the present invention.

As shown in FIG. 15, a plurality of events is displayed on a logarithmic timeline TL1. The event positioned at the top of the timeline TL1 corresponds to the event data file having the latest creation date, while the event positioned at the bottom of the timeline TL1 corresponds to the event data file having the earliest creation date.

The cluster generator 1102 calculates a time period (“distance time period”) between the two adjacent events, and compares the distance time period with a reference time period. When the distance time period is smaller than the reference time period, the corresponding two adjacent events are grouped into one cluster.

In this exemplary embodiment, the above clustering operation is performed in five clustering steps, as illustrated in FIG. 15.

In the first clustering step, the cluster generator 1102 compares a distance time period with a first reference time period. As a result, the “File Found” event and the “File Lost” event are grouped into cluster 1.

In the second clustering step, the cluster generator 1102 compares a distance time period with a second reference time period, which is larger than the first reference time period. As a result, the “Blood Donation” event and the “Personnel Transfer” event are grouped into cluster 2.

In the third clustering step, the cluster generator 1102 compares a distance time period with a third reference time period, which is larger than the second reference time period. As a result, the “Office Equipment” event and the “Antivirus Software” event are grouped into cluster 3.

In the fourth clustering step, the cluster generator 1102 compares a distance time period with a fourth reference time period, which is larger than the third reference time period. As a result, the “Mail Server Restored” event and the “Mail Server Down” event are grouped into first cluster 4. In addition, the cluster 2 including the “Blood Donation” and “Personnel Transfer” events and the cluster 1 including the “File Found” and “File Lost” events are grouped into a second cluster 4.

In the fifth clustering step, the cluster generator 1102 compares a distance time period with a fifth reference time period which is larger than the fourth reference time period. As a result, the second cluster 4 including the “Blood Donation,” “Personnel Transfer,” “File Found,” and “File Lost” events and the “Newspaper Article” event are grouped into cluster 5. In this exemplary embodiment, the first to fifth reference time periods may be determined based on a size of the frame or an average character size of the events in the frame, for example.

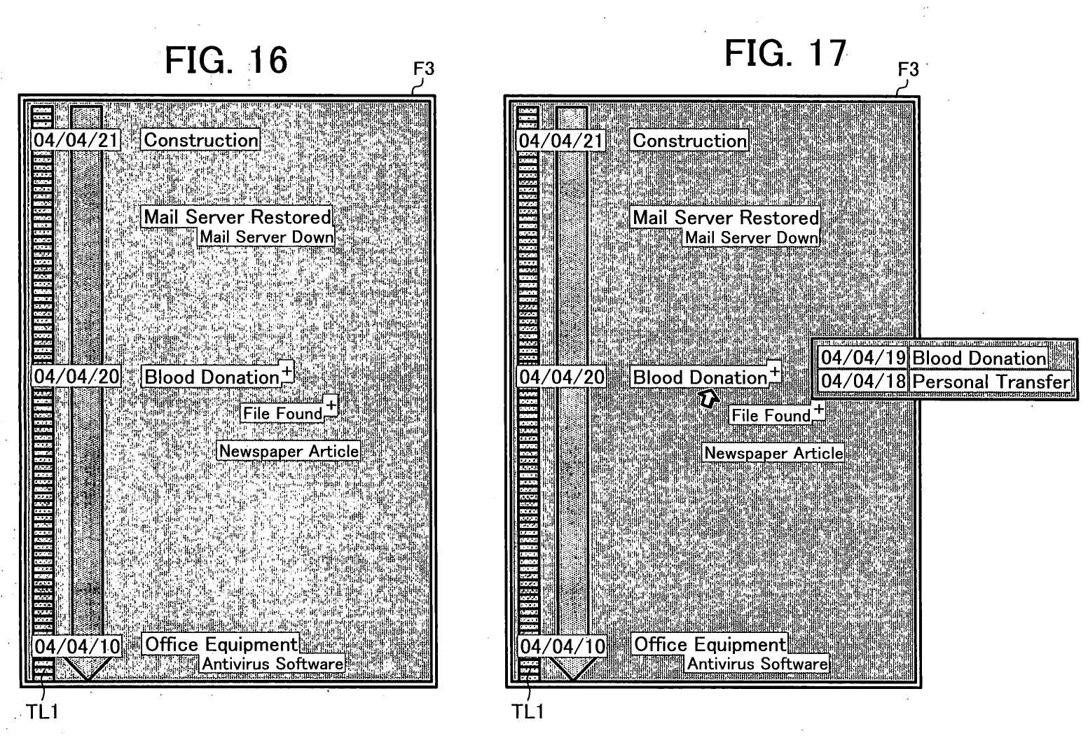

After performing these five clustering steps, four main clusters (indicated by the arrows A) and four sub-clusters (indicated by the arrows B) remain. The event display 1101 displays the events by cluster in the frame F3 as illustrated in FIG. 16. As shown in FIG. 16, the event belonging to the main cluster is displayed with a font larger than the font of the event belonging to the sub-cluster. Further, the event belonging to the sub-cluster may be indented.

In this exemplary embodiment, the mark “+” placed above the “Blood Donation” event in FIG. 16 indicates an event belonging to the cluster represented by the “Blood Donation” event. If the user selects the mark “+” with the input device, the event display 1101 may display the file name of the corresponding event data file, i.e., “Personnel Transfer,” on the timeline TL1, as illustrated in FIG. 17. In this exemplary embodiment, the file name of the corresponding event data file may be displayed in a newly created frame, such as a pop-up window, for example.

In this exemplary embodiment, the event display 1101 displays the file names of the event data files belonging to the main cluster and the sub-cluster. However, any number of clusters may be displayed with the file name, depending on the number of clustering steps performed by the cluster generator 1102, or depending on the number of clusters being considered by the event display 1101.

Further, any one of the known clustering methods may be used in the above clustering steps, such as Chameleon clustering method, for example.

Furthermore, in addition to the event time information displayed on the timeline, the cluster generator 1102 may use any other information related to the event data files for clustering.

In this exemplary embodiment, the importance level of an event data file is not considered. However, the event display 1101 may change the font size or the indent size according to the importance level, in a substantially similar manner as described with reference to FIG. 1, for example. Further, the event display 1101 may be provided with the event display controller 103 of FIG. 1, for example.

The event display apparatus 1100 performs an operation of providing an event data file in a substantially similar manner as described with reference to FIG. 9. The differences include the addition of clustering, preferably performed right before Step S605.

Alternatively, the event display apparatus 1100 may perform an operation of providing an event data file in a substantially similar manner as described with reference to FIG. 12. The differences include the addition of clustering, preferably performed right before Step S907. In such a case, the storage device 108 may be replaced with the communication device 804.

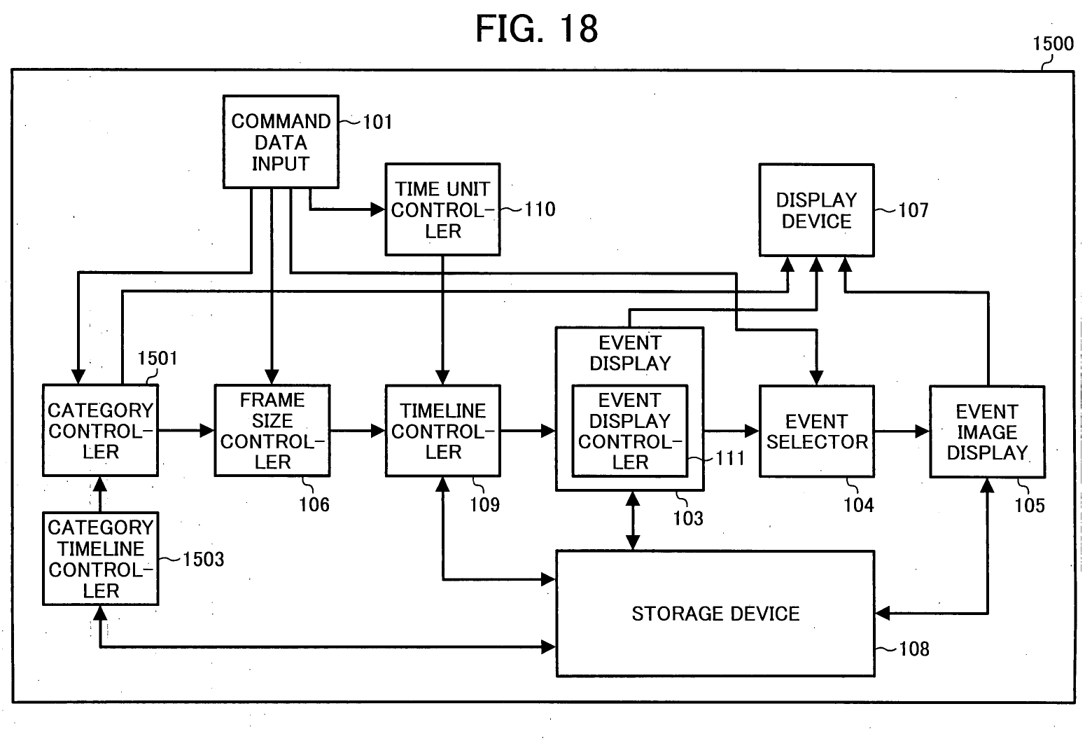

Referring to FIG. 18, an event display apparatus 1500 is now explained according to an exemplary embodiment of the present invention. The event display apparatus 1500 is capable of displaying categories based on a logarithmic timescale in a three-dimensional form. The event display apparatus 1500 of FIG. 18 is substantially similar in structure to the event display apparatus 100 of FIG. 1. The differences include category controller 1501 and category timeline controller 1503.

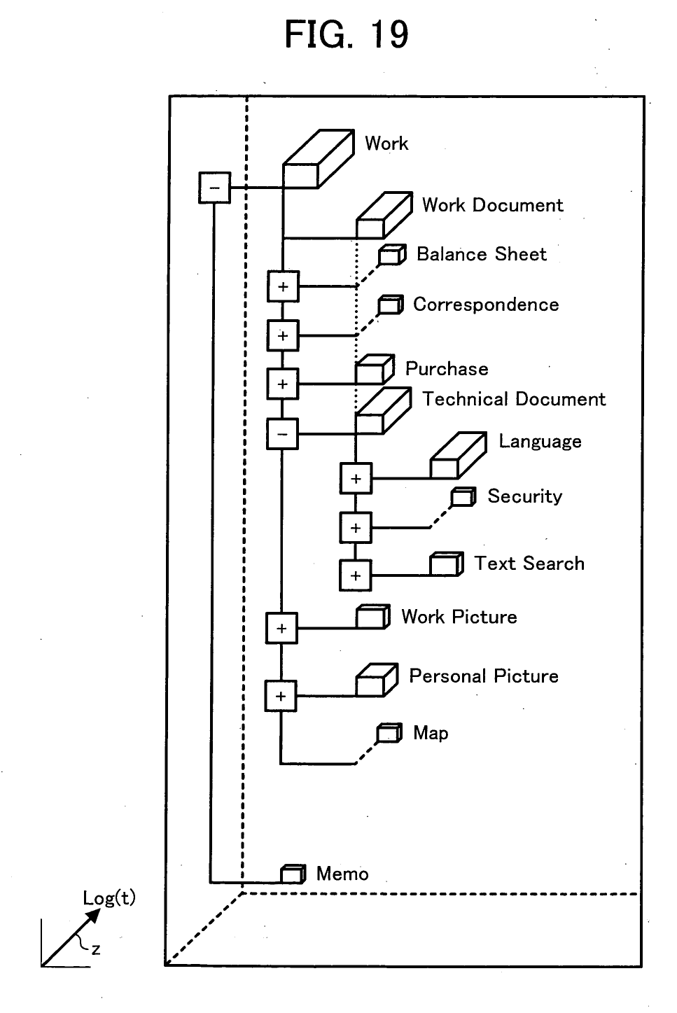

The category controller 1501 displays the categories of the events on the display device 107 in the three-dimensional form, preferably in a tree structure, as illustrated in FIG. 19, for example. As shown in FIG. 19, each category is represented by a rectangular box.

The category timeline controller 1503 generates a category timeline (not shown in FIG. 19) in the Z axis of the display device 107 for each of the categories. Further, the category timeline controller 1504 determines which portion of the category timeline corresponds to a time period represented by the category.

First, the category timeline controller 1503 determines a starting date and an ending date of the category timeline, based on the category time information. In this exemplary embodiment, the stating date is set to the current date, while the ending date is set to the earliest date (“earliest category date”) obtained from the category time information. For example, referring to the category management table of FIG. 3, the earliest category date is “19920101120032,” which is the creation date of the “Personal Picture” category or the “Travel Picture” category. The category timeline controller 1503 then calculates a time period T between the current date and the earliest category date.

Next, the category timeline controller 1503 obtains the maximum length Lz in the Z axis direction of the display device 107. The maximum Z axis length Lz is previously determined based on various characteristics of the display device 107. In this exemplary embodiment, the length of the timeline for each of the categories is made substantially equal to the maximum Z axis length Lz. Further, the length of the timeline, i.e., the maximum Z axis length Lz, is assumed to correspond to the time period T between the current date and the earliest category date. Accordingly, the unit length l in the Z axis corresponding to the logarithmic value 1 can be calculated using the following equation: l=Lz/log(T). This unit length l is used as a conversion factor for converting time information expressed in logarithm to positional information expressed in number of pixels to be displayed on the display device 107.

To determine the portion of the category timeline corresponding to a selected category, the category timeline controller 1503 first obtains the starting date of the timeline for the selected category. In this exemplary embodiment, the category timeline controller 1503 obtains the last modified date of the selected category, and calculates a time period between the current date, i.e., the starting date of the category timeline, and the last modified date of the selected category. In the exemplary case of the “Travel Picture” category shown in FIG. 3, the category timeline controller 1503 obtains a time period between the last modified date (2004/03/22) and the current date. The logarithmic value of the obtained time period is further multiplied by the conversion factor of l to obtain positional information of the category, which indicates the position of the category timeline at which the selected category starts.

The category timeline controller 1503 further obtains the ending date of the timeline for the selected category. In this exemplary embodiment, the category timeline controller 1503 obtains the creation date of the selected category, and calculates a time period between the current date, i.e., the starting date of the category timeline, and the creation date of the selected category. In the exemplary case of the “Travel Picture” category shown in FIG. 3, the category timeline controller 1503 obtains a time period between the creation date (1992/01/01) and the current date. The logarithmic value of the obtained time period is further multiplied by the conversion factor of l to obtain positional information of the category, which indicates the position of the category timeline at which the selected category ends.

Based on the starting date and the ending date of the category, the category controller 1501 displays the box representing the category, as illustrated in FIG. 19, for example. At this time, the category controller 1501 displays the name of the category using the category data.

Referring back to FIG. 18, once the categories of the events are displayed in the three-dimensional form, a user may select one of the categories with the input device. The category controller 1501 selects the category selected by the user.

Once the category is selected, the event display 103 displays a frame for the selected category. Within the frame, the event display 103 further displays events belonging to the selected category.

The event display apparatus 1500 performs an operation of providing an event data file in a substantially similar manner as described with reference to FIG. 9.

Alternatively, the event display apparatus 1500 may perform an operation of providing an event data file in a substantially similar manner as described with reference to FIG. 12. In such a case, the storage device 108 may be replaced with the communication device 804.

Further, the event display apparatus 1500 may be additionally provided with the cluster generator 1102.

Furthermore, the length of the category timeline may not correspond to the time period between the current date and the earliest category date.

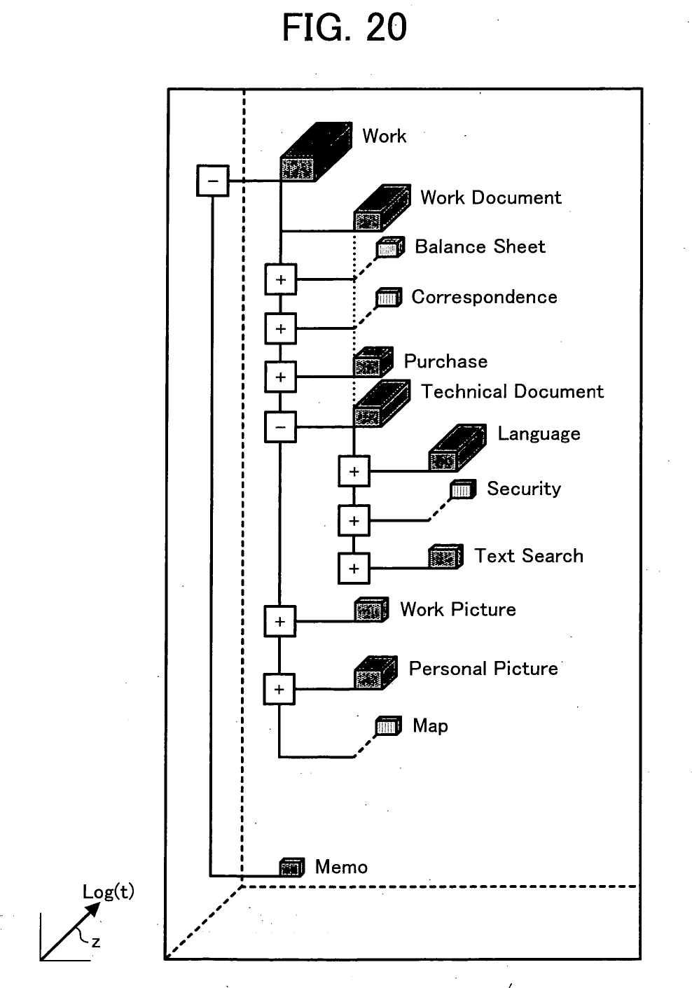

Furthermore, when displaying a box representing a specific category, the category controller 1501 may select a specific color or intensity level of the box according to the time information of the corresponding category. For example, as illustrated in FIG. 20, if a box is located at a position relatively close to the starting date of the category timeline, the box may be assigned with a darker color. If a box is located at a position relatively far from the starting date of the category timeline, the box may be assigned with a lighter color.

Numerous additional modifications and variations are possible in light of the above teachings. It is therefore to be understood that within the scope of the appended claims, the disclosure of this patent specification may be practiced by methods and apparatuses other than those specifically described herein.

For example, elements and/or features of different illustrative embodiments may be combined with each other and/or substituted for each other within the scope of this disclosure and appended claims.

Furthermore, as mentioned above, the present invention may be implemented using one or more microprocessors and/or signal processors programmed according to the teachings of the present disclosure. Alternatively, as mentioned above, the present invention may be implemented by an ASIC (Application Specific Integrated Circuit), prepared by an appropriate network of component circuits or by a combination thereof according to the present disclosure.

What is claimed as new and desired to be protected by Letters Patent of the United States is:

1. An event display method, comprising the steps of:
displaying one or more categories, with each category including one or more events;
selecting one of the categories;
generating a timeline, starting at a starting date for the selected category, based on a logarithmic scale;
determining a position of each of the events belonging to the selected category on the timeline from the starting date of the timeline; and
displaying each of the events belonging to the selected category at the determined position of the timeline.

2. The event display method of claim 1, further comprising the step of:
selecting one of the events being displayed.

3. The event display method of claim 2, further comprising the step of:
displaying an event data file corresponding to the selected event.

4. The event display method of claim 1, further comprising the step of:
selecting a time unit of the timeline, wherein each of the events belonging to the selected category is displayed in the selected time unit.

5. The event display method of claim 1, further comprising the step of:
converting the timeline from the logarithmic scale to a linear scale.

6. The event display method of claim 1, further comprising the step of:
forming a frame having a predetermined size for the selected category, wherein the timeline is displayed within the frame.

7. The event display method of claim 6, wherein the timeline has a length corresponding to the size of the frame.

8. The event display method of claim 1, wherein the timeline ends at an ending date preceding the starting date.

9. The event display method of claim 8, wherein the ending date is determined based on category time information.

10. The event display method of claim 9, wherein the starting date is determined based on category time information.

11. The event display method of claim 9, wherein the starting date is determined based on current date information.

12. The event display method of claim 1, wherein the determining step comprises the step of:
obtaining, for each of the events belonging to the selected category, a time period between the starting date of the timeline and an event date of the event.

13. The event display method of claim 12, wherein the determining step further comprises the step of:
converting the obtained time period with a conversion factor, wherein the determined position corresponds to the converted obtained time period.

14. The event display method of claim 1, wherein the determining step comprises the step of:
obtaining event time information for each of the events belonging to the selected category, wherein the position of each of the events is determined based on the corresponding event time information.

15. The event display method of claim 14, wherein the displaying step comprises the step of:
obtaining event properties information for each of the events belonging to the selected category.

16. The event display method of claim 15, wherein the displaying step further comprises the step of:
changing a view of the displayed events based on at least one of the event properties information and the event time information.

17. The event display method of claim 15, wherein the displaying step further comprises the step of:
clustering the events belonging to the selected category into one or more clusters, based on at least one of the event properties information and the event time information.

18. The event display method of claim 17, wherein the displaying step further comprises the step of:
changing a view of the displayed events based on the result of the clustering step.

19. The event display method of claim 1, wherein the one or more categories are displayed in a three-dimensional form.

20. The event display method of claim 19, wherein the displaying step comprises the step of:
generating a category timeline for each of the categories based on a logarithmic scale, with each category timeline indicating a time period represented by the corresponding category.

21. The event display method of claim 19, wherein the displaying step further comprises the steps of:
obtaining category time information for each of the categories; and
changing a view of the categories based on the category time information.

22. An event display method, comprising the steps of:
displaying one or more categories, with each category including one or more events;
selecting one of the categories;
generating a timeline starting at a starting date, for the selected category, based on a logarithmic scale;
determining a position of each of the events belonging to the selected category on the timeline from the starting date of the timeline;
selecting one or more of the events belonging to the selected category for display; and
displaying the selected events on the determined positions of the timeline.

23. A category display method, comprising the steps of:
obtaining category data indicating one or more categories to be displayed;
generating, for each of the categories, a category timeline starting at a starting date based on a logarithmic timescale;
determining, for each of the categories, a starting date and an ending date of the category based on category time information;
determining, for each of the categories, a portion of the category timeline corresponding to a time period between the starting date and the ending date; and
displaying each of the categories at the determined portion of the category timeline.

24. An event display system, comprising:
a processor; and
a storage device configured to store a plurality of instructions which, when activated by the processor, cause the processor to perform an event display operation, comprising:
displaying one or more categories with each category including one or more events;
selecting one of the categories;
generating a timeline starting at a starting date for the selected category based on a logarithmic scale;
determining a position of each of the events belonging to the selected category on the timeline, from the starting date of the timeline; and
displaying each of the events belonging to the selected category on the determined position of the timeline.

25. The event display system of claim 24, wherein the storage device further stores one or more event data files.

26. The event display system of claim 25, wherein the operation further comprises:
selecting one of the events being displayed; and
obtaining an event data file corresponding to the selected event for display.

27. The event display system of claim 25, wherein the storage device further stores:
event time information for each of the event data files.

28. The event display system of claim 27, wherein the storage device further stores:
event properties information for each of the event data files.

29. An event display apparatus, comprising:
means for displaying one or more categories with each category including one or more events;
means for selecting one of the categories;
means for generating a timeline starting at a starting date, for the selected category, based on a logarithmic scale;
means for determining a position of each of the events belonging to the selected category on the timeline, from the starting date of the timeline; and
means for displaying each of the events belonging to the selected category at the determined position of the timeline.

30. The event display apparatus of claim 29, further comprising:
means for selecting a time unit of the timeline, wherein each of the events belonging to the selected category is displayed in the selected time unit.

31. The event display apparatus of claim 29, further comprising:
means for converting the timeline from the logarithmic scale to a linear scale.

32. An event display apparatus, comprising:
means for displaying one or more categories with each category including one or more events;
means for selecting one of the categories;
means for generating a timeline starting at a starting date for the selected category based on a logarithmic scale;
means for determining a position of each of the events belonging to the selected category on the timeline, from the starting date of the timeline;
means for selecting one or more of the events belonging to the selected category for display; and
means for displaying the selected events on the determined positions of the timeline.

33. A category display apparatus, comprising:
means for obtaining category data indicating one or more categories to be displayed;
means for generating, for each of the categories, a category timeline starting at a starting date, based on a logarithmic timescale;
means for determining, for each of the categories, a starting date and an ending date of the category based on category time information;
means for determining, for each of the categories, a portion of the category timeline corresponding to a time period between the starting date and the ending date; and
means for displaying each of the categories at the determined portion of the category timeline.

34. A computer program product stored on a computer readable storage medium for carrying out a method when running on an apparatus, the method comprising the steps of:
displaying one or more categories, with each category including one or more events;
selecting one of the categories;
generating a timeline starting at a starting date, for the selected category, based on a logarithmic scale;
determining a position of each of the events belonging to the selected category on the timeline, from the starting date of the timeline; and
displaying each of the events belonging to the selected category at the determined position of the timeline.

35. The product of claim 34, wherein the operation further comprises the steps of:
selecting one of the events being displayed; and
displaying an event data file corresponding to the selected event.
